(19) United States
(12) Patent Application Publication
(10) Pub. No.: US 2026/0112052 A1
(43) Pub. Date: Apr. 23, 2026

(54) VIDEO MANUAL CREATION DEVICE AND VIDEO MANUAL CREATION METHOD

(71) Applicant: FANUC CORPORATION, Minamitsuru-gun, Yamanashi (JP)

(72) Inventor: Tomofumi UWANO, Yamanashi (JP)

(21) Appl. No.: 19/117,719

(22) PCT Filed: Oct. 31, 2022
(86) PCT No.: PCT/JP2022/040786

§ 371 Date: Apr. 2, 2025

(51) Int. Cl. H04N 21/81; G06T 7/73; G06V 20/52; H04N 21/845

(52) U.S. Cl. CPC H04N 21/816; G06T 7/73; G06V 20/52; H04N 21/8456; G06T 2207/30196; G06V 2201/07

(57) ABSTRACT

A moving image manual creation device includes a machine operation panel registration unit that registers an image of the operation panel of a machine, a signal registration unit that registers each button on the operation panel in the image and a signal for controlling the operation panel by an operation of each button on the operation panel in association with each other, and a signal data change time extraction unit that extracts a time of a change in the registered signal. The device also includes a frame detection unit that detects, based on the extracted time, from the moving image including an operation performed on the operation panel, a frame at which a button corresponding to the changed signal was operated, and a moving image creation unit that creates a moving image displaying the button on the image of the operation panel when the detected frame is displayed.

### TECHNICAL FIELD

The present invention relates to a video manual creation device and a video creation method for creating a video manual indicating procedures for operating buttons of a machine.

### BACKGROUND ART

For example, in a controller that has a display screen to allow operation of a molded product ejector or the like, there is known a technique for reading a video manual and displaying the video manual on a display screen as a video, the video manual containing video information that provides a description relating to handling of the molded product ejector in the form of a video based on an actually captured video, a simulation video, or animation. See, for example, Patent Document 1.

### CITATION LIST

### Patent Document

Patent Document 1: Japanese Unexamined Patent Application, Publication No. 2008-246712

### DISCLOSURE OF THE INVENTION

### Problems to Be Solved by the Invention

However, the technique described in Patent Document 1 has a problem that it takes time to create a video for a description relating to the handling of a machine because the video contains an actually captured video of the machine as well as a simulation video, an animation, or the like.

Moreover, in a video including an operation performed by a worker, it may be difficult to recognize which button is pressed by the worker.

When a signal corresponding to a button operation of the worker for controlling the machine is acquired from the machine, a delay may occur, and this may cause deviation between timing of the worker pressing the button in the video and timing of displaying the pressed button.

It is also difficult and time consuming to edit a long-term video acquired by a surveillance camera and the like.

Accordingly, it is desired to make it possible to easily create an easy-to-understand video manual that indicates which button is pressed in combination with a video of button operation of a worker.

### Means for Solving the Problems

One aspect of a video manual creation device includes: a machine operation panel registration unit configured to register an image of an operation panel of a machine; a signal registration unit configured to register each button on the operation panel in the image registered by the machine operation panel registration unit and a signal for controlling the operation panel by an operation of each button on the operation panel in association with each other; a signal data change time extraction unit configured to extract a time of a change in the signal registered in the signal registration unit; a frame detection unit configured to detect, based on the time extracted by the signal data change time extraction unit, from a video including an operation performed on the operation panel by a worker, a frame at which a button corresponding to the changed signal was operated by the worker; and a video creation unit configured to create a video displaying the button that was operated by the worker on the image of the operation panel registered by the machine operation panel registration unit when the frame detected by the frame detection unit is displayed.

One aspect of a video manual creation method is a video creation method for causing a computer to function as a video manual creation device, the video manual creation method including: a machine operation panel registration step of registering an image of an operation panel of a machine; a signal registration step of registering each button on the operation panel in the registered image and a signal for controlling the operation panel by an operation of each button on the operation panel in association with each other; a signal data change time extraction step of extracting a time of a change in the registered signal; a frame detection step of detecting, based on the extracted time, from a video including an operation performed on the operation panel by a worker, a frame at which a button corresponding to the changed signal was operated by the worker; and a video creation step of creating a video displaying the button that was operated by the worker on the registered image of the operation panel when the detected frame is displayed.

### BRIEF DESCRIPTION OF THE DRAWINGS

FIG. 1 is a functional block diagram showing a functional configuration example of a video manual creation system 1 according to a first embodiment;

FIG. 2 is a diagram showing an example of a registered image of an operation panel of a machine;

FIG. 3 is a diagram showing an example of a registered signal table;

FIG. 4 is a diagram showing an example of the relationship between a video and a time of a change in signal;

FIG. 5 is a diagram showing a display example of a video manual;

FIG. 6 is a flowchart illustrating a video creation process of a video manual creation device;

FIG. 7 is a diagram showing an example of the configuration of a video manual creation system according to a second embodiment;

FIG. 8 is a diagram showing an example of an image area of the operation panel detected by an operation panel detection unit and a joint position of a worker estimated by a joint position estimation unit;

FIG. 9 is a flowchart illustrating the video creation process of the video manual creation device;

FIG. 10 is a diagram showing an example of the relationship among an operation panel use time by the worker, a signal change, and a delay time;

FIG. 11 is a diagram showing an example of the configuration of a video manual creation system according to a third embodiment; and

FIG. 12 is a flowchart illustrating the video creation process of the video manual creation device.

### PREFERRED MODE FOR CARRYING OUT THE INVENTION

### First Embodiment

First, the outline of the present embodiment will be described. In the present embodiment, a video manual creation device registers an image of an operation panel of a machine, and also registers each button on the operation panel in the registered image and a signal for controlling the operation panel by an operation of each button on the operation panel in association with each other. The video manual creation device extracts a time of a change in signal and detects, based on the extracted time, from the video including an operation performed on the operation panel by a worker, a frame at which a button corresponding to the changed signal was operated by the worker. The video manual creation device creates a video displaying the button that was operated by the worker on the registered image of the operation panel when the detected frame is displayed.

Therefore, according to the present embodiment, it is possible to easily create an easy-to-understand video manual that indicates which button is pressed in combination with a video of button operation of the worker.

This concludes the description of the outline of the present embodiment.

Now, the configuration of the present embodiment is described in detail with reference to the drawings.

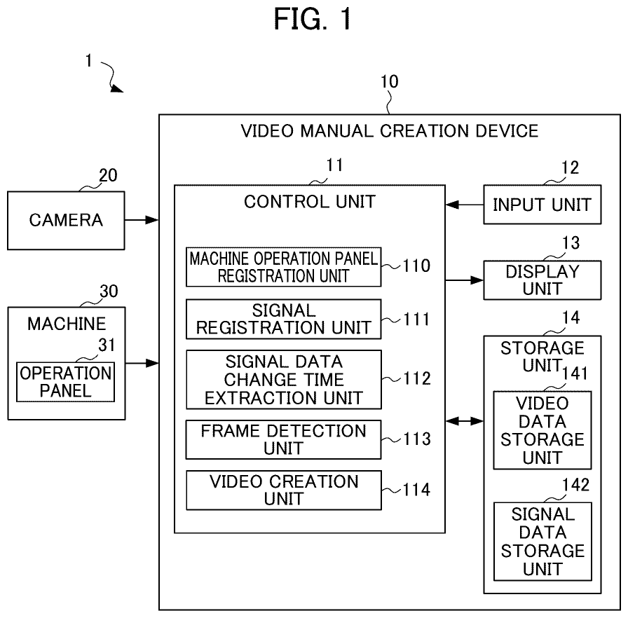

FIG. 1 is a functional block diagram showing a functional configuration example of the video manual creation system 1 according to the first embodiment.

As shown in FIG. 1, the video manual creation system 1 includes a video manual creation device 10, a camera 20, and a machine 30.

The video manual creation device 10, the camera 20, and the machine 30 may be connected to each other via an unshown network such as a local area network (LAN) or the Internet. Alternatively, the video manual creation device 10, the camera 20, and the machine 30 may be connected directly to each other via an unshown connection interface.

The camera 20 is a surveillance camera or the like that is placed in a factory or other locations where the machine 30 is installed. For example, the camera 20 preferably captures two-dimensional frames in which an operation panel 31 included in the machine 30 and a worker operating the operation panel 31 are projected onto a plane perpendicular to an optical axis of the camera 20 at a predetermined frame rate (for example, 30 fps, etc.). Without being limited to this, the camera 20 may capture the operation panel 31 and buttons or the like on the operation panel 31 from any angle. The camera 20 outputs the captured frames as a video to the video manual creation device 10 which is described later. The image data captured by the camera 20 may be visible light images such as RGB color images, gray scale images, and depth images.

Here, in FIG. 1, the video manual creation device 10 is connected with one camera 20. However, without being limited thereto, the video manual creation device 10 may be connected with two or more cameras 20.

The machine 30, for example, is a machine tool that includes a numerical control device (not shown) that is well known to those skilled in the art. The machine 30 operates based on a machining program executed by the numerical control device which is not shown, and also operates based on an operation performed on the operation panel 31 of the machine 30 by the worker. In addition, the machine 30 outputs a signal for controlling the operation panel 31, which is generated by a button operation performed by the worker on the operation panel 31, to the video manual creation device 10 which is described later.

As described later, the machine 30 may also be a robot control device that controls a robot.

The operation panel 31 has a plurality of buttons or the like arranged to operate or set the machine 30.

### Video Manual Creation Device 10

The video manual creation device 10 is a well-known computer including a control unit 11, an input unit 12, a display unit 13, and a storage unit 14. The control unit 11 includes a machine operation panel registration unit 110, a signal registration unit 111, a signal data change time extraction unit 112, a frame detection unit 113, and a video creation unit 114.

### Input Unit 12

The input unit 12 is, for example, a keyboard, a touch panel placed in the display unit 13 described later, or the like, which receives input from a user.

### Display Unit 13

The display unit 13 is, for example, a liquid crystal display or the like. The display unit 13 displays, for example, a video manual created by the video manual creation device 10 based on an input operation of the user via the input unit 12 as described later.

### Storage Unit 14

The storage unit 14 is a solid state drive (SSD), a hard disk drive (HDD), or the like, which stores a machining program for operating the machine 30, and the like. The storage unit 14 may also store an image of the operation panel 31 of the machine 30 registered by the machine operation panel registration unit 110 described later and a signal table or the like, the signal table including each button of the operation panel 31 and a signal for controlling the operation panel 31 by an operation of each button, which are registered in association with each other by the signal registration unit 111 described later. The storage unit 14 also includes a video data storage unit 141 and a signal data storage unit 142.

The video data storage unit 141 stores video data captured by the camera 20 as described above.

As described above, the signal data storage unit 142 stores the signal for controlling the operation panel 31 in response to an operation of the button on the operation panel 31 of the machine 30 by the worker. Specifically, the video manual creation device 10 acquires a signal for controlling the operation panel 31 for each button at a predetermined time interval (for example, 1 second) through a network not shown, and stores the acquired signals as signal data in the signal data storage unit 142.

### Control Unit 11

The control unit 11, which is well known for those skilled in the art, includes a central processing unit (CPU), a read only memory (ROM), a random access memory (RAM), a complementary metal-oxide-semiconductor (CMOS) memory, or other components, which are configured to be communicable with each other via a bus.

The CPU is a processor that controls the entire video manual creation device 10. The CPU reads a system program and application programs stored in the ROM via the bus, and controls the entire video manual creation device 10 in accordance with the system program and application programs. Thus, as shown in FIG. 1, the control unit 11 is configured to implement the functions of the machine operation panel registration unit 110, the signal registration unit 111, the signal data change time extraction unit 112, the frame detection unit 113, and the video creation unit 114. The RAM stores various typed of data such as temporary calculation data, display data, and the like. The CMOS memory is configured as a non-volatile memory that is backed up by a battery not shown and retains a storage state even when the power of the video manual creation device 10 is turned off.

The machine operation panel registration unit 110 registers an image of the operation panel 31 of the machine 30.

Specifically, the machine operation panel registration unit 110 may, for example, clip an image area of the operation panel 31 of the machine 30 from the frames of the video captured by the camera 20, and stores and registers the clipped image of the operation panel 31 of the machine 30 in the storage unit 14.

Alternatively, the user uses a digital camera, a smartphone, or the like to capture the operation panel 31 of the machine 30. The machine operation panel registration unit 110 may acquire the image of the operation panel 31 of the machine 30 captured by the digital camera or the like of the user, and store and register the acquired image of the operation panel 31 of the machine 30 in the storage unit 14.

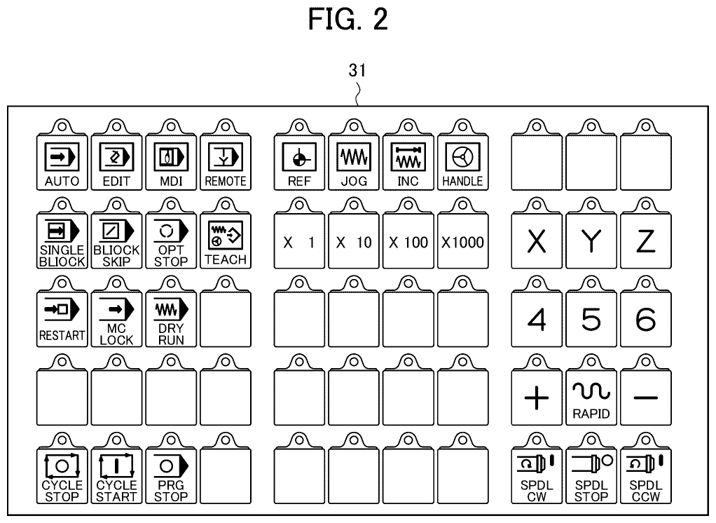

FIG. 2 is a diagram showing an example of the registered image of the operation panel 31 of the machine 30.

The signal registration unit 111 registers each button on the operation panel 31 in the image registered by the machine operation panel registration unit 110 and a signal for controlling the operation panel 31 by an operation of each button on the operation panel 31 in association with each other.

Specifically, the signal registration unit 111 displays, for example, an image of the operation panel 31 registered in the machine operation panel registration unit 110 on the display unit 13. The signal registration unit 111 arranges a rectangular mark of a signal corresponding to the position of each button on the image of the operation panel 31 displayed as shown in FIG. 3, based on the user's input operation through the input unit 12. The signal registration unit 111 receives, in response to an input operation of the user, button names for the arranged rectangular marks and signal names that are output upon pressing of the buttons, generates a registered signal table shown in FIG. 3, and stores the generated registered signal table in the storage unit 14.

As shown in FIG. 3, the registered signal table has storage areas for “rectangular mark”, “button name”, and “signal name”.

For example, in the storage area of the “rectangle mark” in the registered signal table, a rectangle arranged for each button on the operation panel 31 is stored. In FIG. 3, a line type of the rectangle mark is made different for each button, though a line color (for example, red, blue, etc.) of the rectangle mark may be made different for each button. In the storage area of “button name” in the registered signal table, a name such as “AUTO” and “EDIT” is stored for each button where the rectangular mark is arranged based on the input operation of the user.

In the storage area of “signal name” in the registered signal table, a signal name such as “signal A” and “signal B” is stored, the signal name being output when each button where the rectangular mark is arranged is pressed in response to the input operation of the user.

The signal data change time extraction unit 112 extracts a time of a change in signal, for example, a change from OFF to ON, from ON to OFF, or the like, in the signal data stored in the signal data storage unit 142, for example.

The signal data change time extraction unit 112 may also identify the signal name of a changed signal.

The frame detection unit 113 detects, based on the time extracted by the signal data change time extraction unit 112, from the video including an operation performed on the operation panel 31 by the worker, a frame at which a button corresponding to the changed signal was operated by the worker.

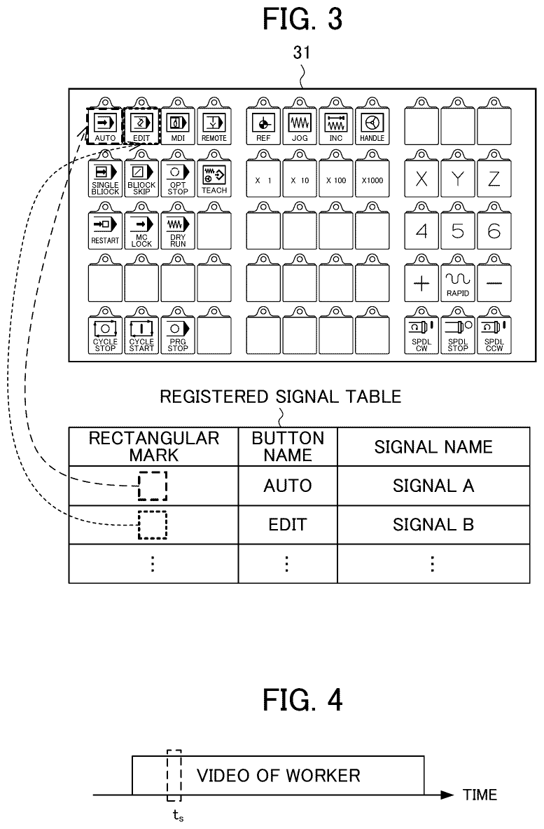

Specifically, as shown in FIG. 4 for example, the frame detection unit 113 detects, from the video including an operation performed on the operation panel 31 by the worker, a frame corresponding to time tₛ of a change in signal. The frame detection unit 113 stores the detected frame in the storage unit 14.

The frame detection unit 113 may detect one frame closest to time tₛ of the change in signal, or may detect a plurality of frames within a predetermined time range (for example, 1 second, etc.) indicated by a dashed rectangle containing time tₛ of the change in signal.

The video creation unit 114 creates a video displaying the button, operated by the worker, on the image of the operation panel 31 in FIG. 2 registered by the machine operation panel registration unit 110. when the frame detected by the frame detection unit 113 is displayed.

Specifically, the video creation unit 114 edits, for example, the video stored in the video creation unit 114 around each frame detected by the frame detection unit 113. The video creation unit 114 identifies, based on the signal name identified by the signal data change time extraction unit 112 and the registered signal table in FIG. 3, the button operated by the worker when each frame detected is displayed. The video creation unit 114 creates a video displaying the position of the button that was operated by the worker on the image of the operation panel 31 in FIG. 2 registered by the machine operation panel registration unit 110, when each frame is displayed with the edited frame. The video creation unit 114 stores the created video as a video manual in the storage unit 14.

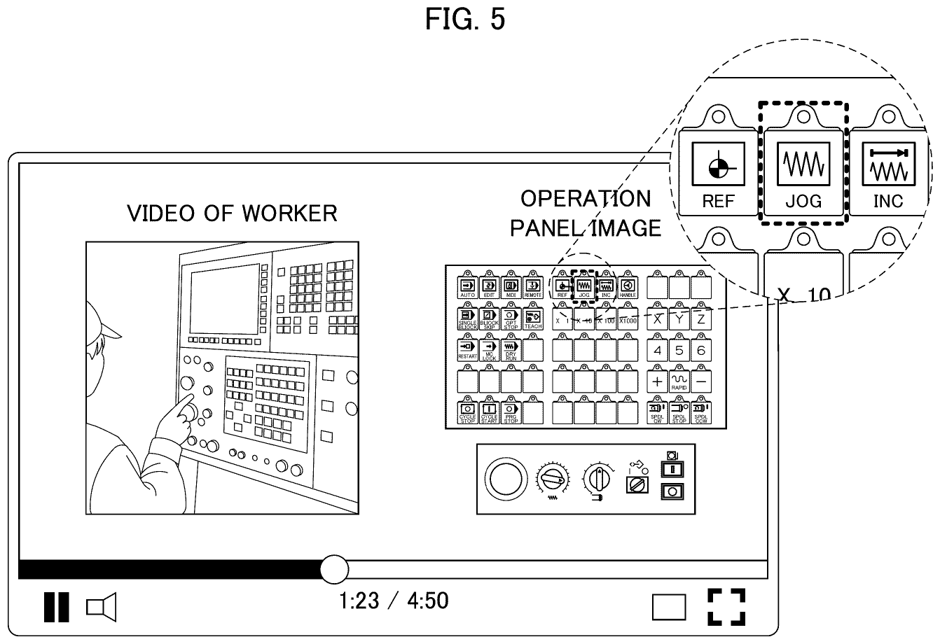

FIG. 5 is a diagram showing a display example of the video manual.

As shown in FIG. 5, the video manual displays a video of the worker in the left half of the screen. The video manual also indicates the position of the button operated by the worker with a thick dashed rectangle as shown by an enlarged view on the upper ride side, along with an image of the operation panel 31 in the right half of the screen.

### Video Creation Process of Video Manual Creation Device 10

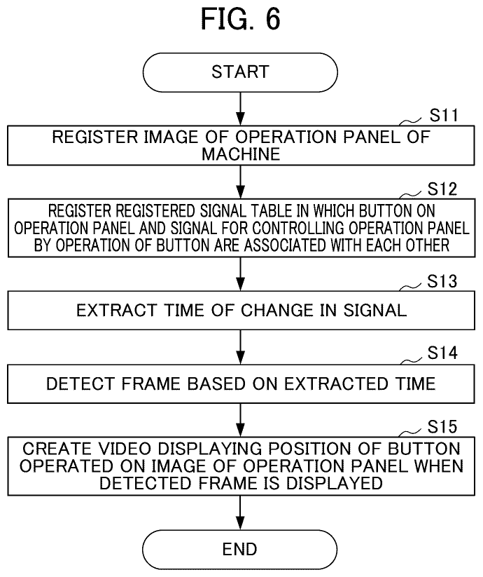

Next, with reference to FIG. 6, the flow of a video creation process of the video manual creation device 10 is described.

FIG. 6 is a flowchart illustrating the video creation process of the video manual creation device 10. The flow shown here is executed by receiving a video creation instruction from the user.

In Step S11, the machine operation panel registration unit 110 registers an image of the operation panel 31 of the machine 30.

In Step S12, the signal registration unit 111 registers a registered signal table in which each button on the operation panel 31 in the image registered in Step S11 and a signal for controlling the operation panel 31 by an operation of each button on the operation panel 31 are associated with each other.

In Step S13, the signal data change time extraction unit 112 extracts a time of a change in signal in the signal data stored in the signal data storage unit 142.

In Step S14, the frame detection unit 113 detects, based on the time extracted in Step S13, from the video including the operation performed on the operation panel 31 by the worker, a frame at which a button corresponding to the changed signal was operated by the worker.

In Step S15, the video creation unit 114 edits the video stored in the video data storage unit 141 around each frame detected in Step S14. Based on the registered signal table registered in Step S12, the video creation unit 114 creates a video that displays the position of the button operated by the worker on the screen of the operation panel 31 registered in Step S11 when each frame is displayed.

As described in the foregoing, the video manual creation device 10 according to the first embodiment can easily create an easy-to-understand video manual that indicates which button is pressed in combination with a video of button operation of the worker.

This concludes the description of the first embodiment.

### Modification Example of First Embodiment

In the first embodiment, the video manual creation device 10 creates a video displaying the position of the button that was operated by the worker on the screen of the operation panel registered when each frame is displayed. However, the video manual creation device 10 is not limited to this. For example, the video manual creation device 10 may create a video displaying only the button that was operated by the worker when each frame is displayed.

### Second Embodiment

Description is now given of a second embodiment. In the first embodiment, the video manual creation device 10 extracts a time of a change in signal, and detects, based on the extracted time, from the video including an operation performed on the operation panel 31 by the worker, a frame at which a button corresponding to the changed signal was operated by the worker. However, the second embodiment is different from the first embodiment in that a video manual creation device 10A detects the operation panel 31 and estimates a joint position of the worker from the video, detects a time of the worker using the operation panel 31 in the video that is before the extracted time of a change in signal, based on the detected image area of the operation panel 31 and the estimated joint position of the worker, and detects a frame at which the worker operated the button corresponding to the changed signal, based on the detected time of the worker using the operation panel 31.

Hence, the video manual creation device 10A according to the second embodiment can easily create an easy-to-understand video manual that indicates which button is pressed in combination with a video of button operation of the worker.

Hereinafter, the second embodiment will be described.

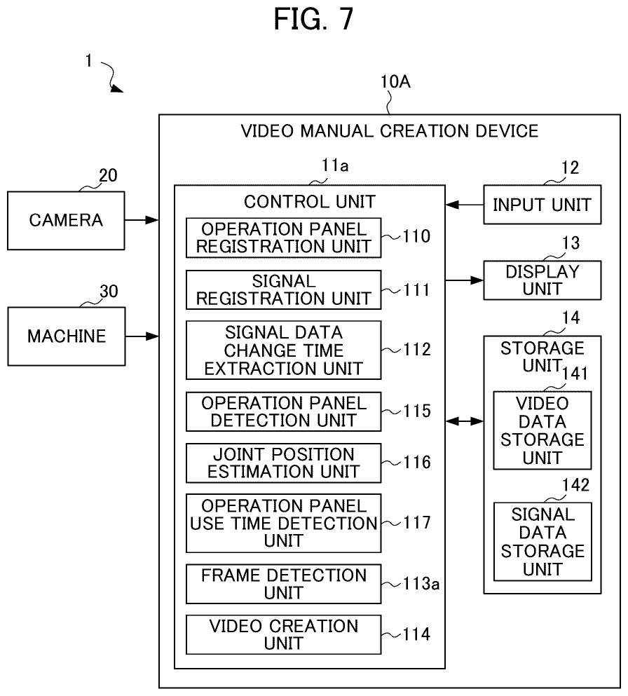

FIG. 7 is a diagram showing an example of the configuration of a video manual creation system according to the second embodiment. Note that component members having functions similar to those of the video manual creation system 1 in FIG. 1 are designated by the same reference numerals to omit detailed description thereof.

As shown in FIG. 7, the video manual creation system 1 according to the second embodiment includes the video manual creation device 10A, the camera 20, and the machine 30.

The camera 20 and the machine 30 have functions similar to the camera 20 and the machine 30 in the first embodiment.

The video manual creation device 10A includes a control unit 11a, the input unit 12, the display unit 13, and the storage unit 14. The control unit 11a includes the machine operation panel registration unit 110, the signal registration unit 111, the signal data change time extraction unit 112, an operation panel detection unit 115, a joint position estimation unit 116, an operation panel use time detection unit 117, a frame detection unit 113a, and the video creation unit 114.

The input unit 12, the display unit 13, and the storage unit 14 have the functions equal to those of the input unit 12, the display unit 13, and the storage unit 14 in the first embodiment.

The video data storage unit 141 and the signal data storage unit 142 have the functions equal to those of the video data storage unit 141 and the signal data storage unit 142 in the first embodiment.

The control unit 11a, which is well known to those skilled in the art, includes a CPU, a ROM, a RAM, a CMOS memory, and the like, which are configured to be communicable with each other via a bus.

The CPU is a processor that controls the entire video manual creation device 10A. The CPU reads a system program and application programs stored in the ROM via the bus, and controls the entire video manual creation device 10A in accordance with the system program and application programs. Hence, as shown in FIG. 7, the control unit 11a is configured to implement the functions of the machine operation panel registration unit 110, the signal registration unit 111, the signal data change time extraction unit 112, the operation panel detection unit 115, the joint position estimation unit 116, the operation panel use time detection unit 117, the frame detection unit 113a, and the video creation unit 114.

The machine operation panel registration unit 110, the signal registration unit 111, the signal data change time extraction unit 112, and the video creation unit 114 have functions similar to those of the machine operation panel registration unit 110, the signal registration unit 111, the signal data change time extraction unit 112, and the video creation unit 114 in the first embodiment.

The operation panel detection unit 115 detects, for example, the operation panel 31 of the machine 30 from the video.

Specifically, the operation panel detection unit 115 uses, for example, the video stored in the video data storage unit 141 and the image of the operation panel 31 registered in the machine operation panel registration unit 110 to detect the image area of the operation panel 31 of the machine 30 from the video by publicly known image analysis (for example, edge detection, etc.).

The joint position estimation unit 116 estimates a joint position of the worker from the video.

Specifically, the joint position estimation unit 116 estimates a coordinate, an angle, or the like of the joint of hands, fingers, or the like of the worker in each frame of the video stored in the video data storage unit 141 by using, for example, publicly known methods (for example, “Motion detection and classification method from multidimensional time series data” by Kosuke Sugano, Kenta Oku, and Kyoji Kawagoe, DEIM Forum 2016 G4-5 or “Feature extraction using LSTM Autoencoder for multimodal sequential data” by Shohei Uezono and Satoshi Ono, materials of the Japanese Society for Artificial intelligence, SIG-KBS-B802-01, 2018).

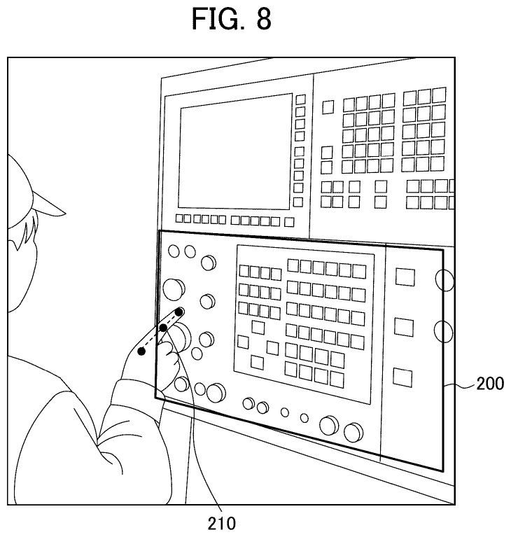

FIG. 8 is a diagram showing an example of an image area 200 of the operation panel detected by the operation panel detection unit 115 and a joint position 210 of the worker estimated by the joint position estimation unit 116. In FIG. 8, the detected image area 200 of the operation panel is shown by a bold rectangle, and the joint position 210 of a finger of the worker is shown by black dots and a dashed line.

The operation panel use time detection unit 117 detects, based on the image area 200 of the operation panel 31 detected by the operation panel detection unit 115 and the joint position 210 of the worker estimated by the joint position estimation unit 116, a time of the worker using the operation panel in the video that is before the time of a change in signal extracted in the signal data change time extraction unit 112.

Specifically, the signal controlling the operation panel 31 of machine 30 may be acquired after a delay from an actual time of the worker using the operation panel, that is, after a delay of, for example, a few milliseconds to a few seconds, due to communication between the video manual creation device 10A and the machine 30 or due to processing of the video manual creation device 10 or other reasons. Therefore, the operation panel use time detection unit 117 determines, for example, whether or not the joint position 210 of the worker estimated in the joint position estimation unit 116 is present in the image area 200 of the operation panel 31 detected by the operation panel detection unit 115 in the video that is before the time of a change in signal extracted in the signal data change time extraction unit 112. The operation panel use time detection unit 117 determines that the worker is using the operation panel 31 when the joint position 210 of the worker is within the image area 200 of the operation panel 31, and detects a time when the pertinent frame was captured as the time of the worker using the operation panel 31.

The frame detection unit 113a detects, based on the time of the worker using the operation panel 31 that is detected by the operation panel use time detection unit 117, the frame at which the operation panel 31 was operated by the worker.

### Video Creation Process of Video Manual Creation Device 10A

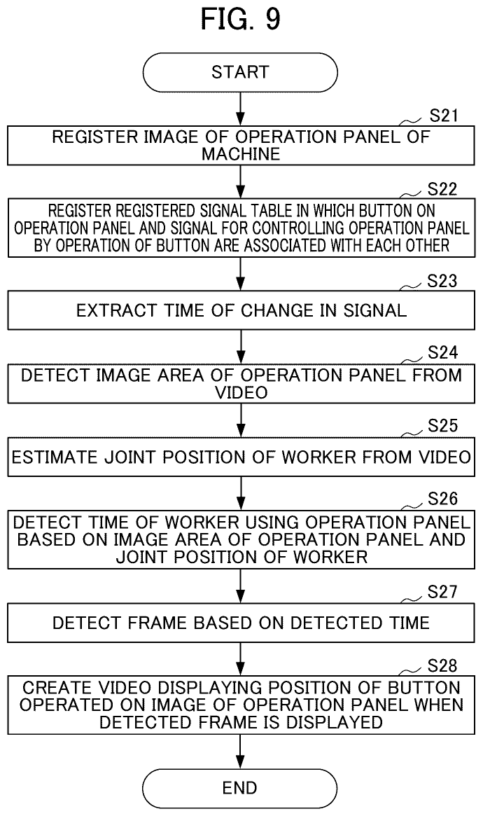

Next, with reference to FIG. 9, the flow of a video creation process of the video manual creation device 10A is described.

FIG. 9 is a flowchart illustrating the video creation process of the video manual creation device 10A. The flow shown here is executed upon reception of a video creation instruction from the user.

Here, the processing in Steps S21 to S23 and Step S28 is the same as the processing in Steps S11 to S13 and Step S15 in FIG. 6, and the description thereof is omitted.

In Step S24, the operation panel detection unit 115 uses the video stored in the video data storage unit 141 and the image of the operation panel 31 registered in Step S21 to detect the image area 200 of the operation panel 31 of the machine 30 from the video.

In step S25, the joint position estimation unit 116 estimates the joint position 210 of the hands or fingers of the worker from the video stored in the video data storage unit 141.

In Step S26, the operation panel use time detection unit 117 detects, based on the image area 200 of the operation panel detected in Step S24 and the joint position 210 of the worker estimated in Step S25, a time of the worker using the operation panel in the video that is before the time of a change in signal extracted in Step S23.

In Step S27, the frame detection unit 113a detects, based on the time extracted in Step S26, a frame at which a button corresponding to the changed signal was operated by the worker.

As described in the foregoing, the video manual creation device 10A according to the second embodiment can easily create an easy-to-understand video manual that indicates which button is pressed in combination with a video of button operation of the worker.

The video manual creation device 10A can also automatically create a video in which timing of the operation of pressing a button in the video coincides with the timing of displaying the pressed button by taking into consideration a delay in signal acquisition.

This concludes the description of the second embodiment.

### Modification Example of Second Embodiment

In the second embodiment, the video manual creation device 10A detects as a time of the worker using the operation panel 31 the time of a frame captured when the estimated joint position 210 of the worker is included in the detected image area 200 of the operation panel 31 in the video that is before the extracted time of a change in signal. However, the video manual creation device 10A is not limited to this.

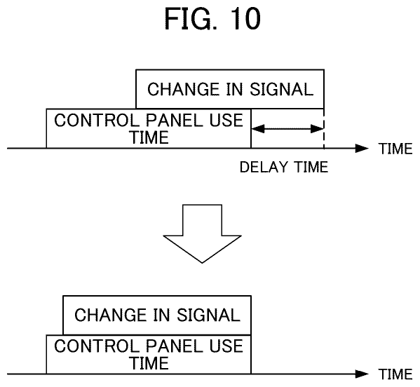

For example, as shown in FIG. 10, the video manual creation device 10A may calculate, as a delay time in signal acquisition, the difference between an end time of an operation of the operation panel 31 that is estimated based on the joint position of the worker and a time when a last change in signal occurred. The video manual creation device 10A may coincide the timing of displaying the pressed button by detecting a frame at which a button corresponding to a changed signal was operated by the worker based on the time obtained by subtracting the calculated delay time from the time of a change in signal.

### Third Embodiment

Description is now given of a third embodiment. In the first embodiment, the video manual creation device 10 extracts the time of a change in signal, and detects, based on the extracted time, from the video including an operation performed on the operation panel 31 by the worker, a frame at which a button corresponding to the changed signal was operated by the worker. The second embodiment is different from the first embodiment in that the video manual creation device 10A detects the operation panel 31 and estimates the joint position of the worker from the video, detects a time of the worker using the operation panel 31 in the video that is before the extracted time of a change in signal based on the detected image area of the operation panel 31 and the estimated joint position of the worker, and detects a frame at which a button corresponding to the changed signal is operated by the worker based on the detected time of the worker using the operation panel. In contrast, in the third embodiment, a video manual creation device 10B clips frames including the worker and also clips frames from a time of occurrence to a time of release of an alarm in the machine 30. The video manual creation device 10B is different from the first embodiment and the second embodiment in that in a video manual for the time of occurrence of an alarm, the video manual creation device 10B creates a video displaying the button operated by the worker when the frame is displayed in a range of each clipped frame.

Hence, the video manual creation device 10B according to the third embodiment can easily create an easy-to-understand video manual that indicates which button is pressed in combination with a video of button operation of the worker.

Hereinafter, the third embodiment will be described.

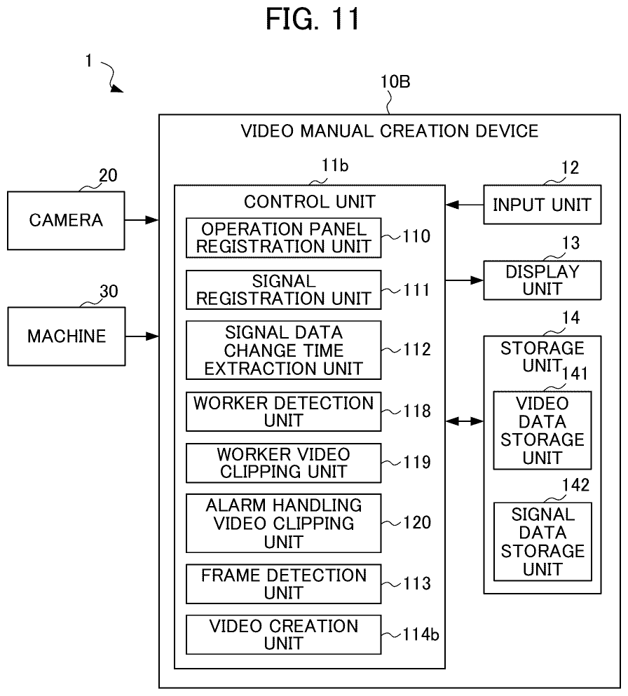

FIG. 11 is a diagram showing an example of the configuration of a video manual creation system according to the third embodiment. Note that component members having functions similar to those of the video manual creation system 1 in FIG. 1 are designated by the same reference numerals to omit detailed description thereof.

As shown in FIG. 11, the video manual creation system 1 according to the third embodiment includes the video manual creation device 10B, the camera 20, and the machine 30.

The camera 20 and the machine 30 have functions similar to the camera 20 and the machine 30 in the first embodiment.

The video manual creation device 10B includes a control unit 11b, the input unit 12, the display unit 13, and the storage unit 14. The control unit 11b includes the machine operation panel registration unit 110, the signal registration unit 111, the signal data change time extraction unit 112, a worker detection unit 118, a worker video clipping unit 119, an alarm handling video clipping unit 120, the frame detection unit 113, and a video creation unit 114b.

The input unit 12, the display unit 13, and the storage unit 14 have the functions equal to those of the input unit 12, the display unit 13, and the storage unit 14 in the first embodiment.

The video data storage unit 141 and the signal data storage unit 142 have functions similar to those of the video data storage unit 141 and the signal data storage unit 142 in the first embodiment.

The control unit 11b, which is well known to those skilled in the art, includes a CPU, a ROM, a RAM, a CMOS memory, and the like, which are configured to be communicable with each other via a bus.

The CPU is a processor that controls the entire video manual creation device 10B. The CPU reads a system program and application programs stored in the ROM via the bus, and controls the entire video manual creation device 10B in accordance with the system program and application programs. Thus, as shown in FIG. 11, the control unit 11b is configured to implement the functions of the machine operation panel registration unit 110, the signal registration unit 111, the signal data change time extraction unit 112, the worker detection unit 118, the worker video clipping unit 119, the alarm handling video clipping unit 120, the frame detection unit 113, and the video creation unit 114b.

The machine operation panel registration unit 110, the signal registration unit 111, the signal data change time extraction unit 112, and the frame detection unit 113 have functions similar to those of the machine operation panel registration unit 110, the signal registration unit 111, the signal data change time extraction unit 112, and the frame detection unit 113 in the first embodiment.

The worker detection unit 118 detects the worker from a video including the operation performed on the machine 30 stored in the video data storage unit 141 by using, for example, publicly known image analysis (for example, edge detection, etc.).

For example, the worker video clipping unit 119 clips a frame including the worker detected by the worker detection unit 118.

The alarm handling video clipping unit 120 clips frames from a time of occurrence to a time of release of an alarm in the machine 30.

Specifically, the alarm handling video clipping unit 120 receives an instruction for creating a video manual on how to handle an alarm indicating abnormality in a main shaft, interference between tool and workpiece, or the like, from the user through the input unit 12, for example. The alarm handling video clipping unit 120 clips the frames from a time of occurrence to a time of release of an alarm in the signal data stored in the signal data storage unit 142.

The video creation unit 144b creates a video displaying the button operated by the worker when the frame detected by the frame detection unit 113 is displayed in a range of the frames clipped in the worker video clipping unit 119 and the frames clipped in the alarm handling video clipping unit 120.

### Video Creation Process of Video Manual Creation Device 10B

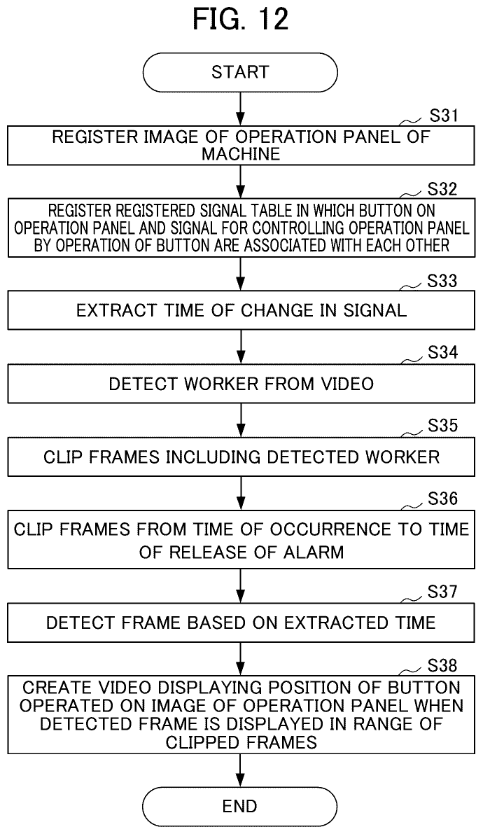

Next, with reference to FIG. 12, the flow of a video creation process of the video manual creation device 10B is described.

FIG. 12 is a flowchart illustrating the video creation process of the video manual creation device 10B. The flow shown here is executed upon reception of a video creation instruction from the user.

Here, the processing in Steps S31 to S33 is the same as the processing in Steps Sil to S13 in FIG. 6, and a detailed description thereof is omitted.

In Step S34, the worker detection unit 118 detects the worker from a video including an operation performed on the machine 30 stored in the video data storage unit 141.

In Step S35, the worker video clipping unit 119 clips the frames including the worker detected in Step S34.

In Step S36, the alarm handling video clipping unit 120 clips the frames from a time of occurrence to a time of release of an alarm in the machine 30.

In Step S37, the frame detection unit 113 detects, based on the time extracted in Step S33, from the video including the operation performed on the operation panel (not shown) by the worker, a frame of the video at which a button corresponding to a changed signal was operated by the worker.

In Step S38, the video creation unit 114b creates a video displaying the button operated by the worker when the frame detected in Step S37 is displayed in a range of the frames clipped in Step S35 and the frames clipped in Step S36.

As described in the foregoing, the video manual creation device 10B according to the third embodiment can easily create an easy-to-understand video manual that indicates which button is pressed in combination with a video of button operation of the worker.

The video manual creation device 10B can create a video manual by automatically clipping a necessary portion for the manual.

This concludes the description of the third embodiment.

As described in the first embodiment, the second embodiment, and the third embodiment, the video manual creation devices 10, 10A, and 10B can easily create an easy-to-understand video manual that indicates which button is pressed in combination with a video of button operation of the worker.

### Modification Example

The first embodiment, the second embodiment, and the third embodiment are configured to be, but not limited to, a machine tool including a numerical control device (not shown). For example, the machine 30 may also be a robot, or a control device that controls the robot.

In the first embodiment, the second embodiment, and the third embodiment, each function included in the video manual creation devices 10, 10A, and 10B can be implemented by hardware, software, or a combination of these. Here, “implemented by software” means “implemented by the computer reading and executing programs”.

The programs can be stored using various types of non-transitory computer readable media and be supplied to the computer. The non-transitory computer readable media include various types of tangible storage media. Examples of the non-transitory computer readable media include magnetic recording media (e.g. flexible disks, magnetic tapes, hard disk drives), magneto-optical recording media (e.g. magneto-optical disks), compact disc read only memories (CD-ROMs), CD-Rs, CD-RWS, semiconductor memories (e.g. mask ROMs, programmable ROMs (PROMs) , erasable PROMs (EPROMs), flash ROMs, and RAMs). The programs may be supplied to the computer using various types of transitory computer readable media. Examples of the transitory computer readable media include electrical signals, optical signals, and electromagnetic waves. The transitory computer readable media can supply the programs to the computer via wired communication channels, such as wires, and optical fibers, or wireless communication channels.

Note that the steps describing a program to be recorded on a recording medium are to include processes that are time-serially performed in a described order as well as processes that are executed in parallel or individually and not necessarily processed in time series order.

Although the present disclosure has been described in detail, the present disclosure is not limited to individual embodiments described above. Various additions, replacements, modifications, partial deletions, and the like can be made for these embodiments without departing from the gist of the present disclosure or without departing from the conceptual thought of the present disclosure derived from the contents and their equivalents defined in claims. These embodiments can also be carried out in combination. For example, in the embodiments described above, the order of each operation and the order of each processing are exemplary and not restrictive. This also applies to the case where numerical values or expressions are used in the description of the embodiments described above.

In connection with the above embodiments and Modification Examples, the following supplements are further disclosed.

### (Supplement 1)

A video manual creation device (10) includes: a machine operation panel registration unit (110) configured to register an image of an operation panel (31) of a machine (30); a signal registration unit (111) configured to register each button on the operation panel (31) in the image registered by the machine operation panel registration unit (110) and a signal for controlling the operation panel (31) by an operation of each button on the operation panel (31) in association with each other; a signal data change time extraction unit (112) configured to extract a time of a change in the signal registered in the signal registration unit (111); a frame detection unit (113) configured to detect, based on the time extracted by the signal data change time extraction unit (112), from a video including an operation performed on the operation panel (31) by a worker, a frame at which a button corresponding to the changed signal was operated by the worker; and a video creation unit (114) configured to create a video displaying the button that was operated by the worker on the image of the operation panel (31) registered by the machine operation panel registration unit (110) when the frame detected by the frame detection unit (113) is displayed.

### (Supplement 2)

The video manual creation device (10A) in supplement 1 includes: an operation panel detection unit (115) configured to detect an image area of the operation panel (31) from the video; a joint position estimation unit (116) configured to estimate a joint position of the worker from the video; and an operation panel use time detection unit (117) configured to, based on the image area (200) of the operation panel (31) detected by the operation panel detection unit (115) and the joint position (210) of the worker estimated by the joint position estimation unit (116), detect a time of the worker using the operation panel in the video that is before the time extracted in the signal data change time extraction unit (112), in which the frame detection unit (113a) detects, based on the time detected by the operation panel use time detection unit (117), a frame capturing the operation performed by the worker.

### (Supplement 3)

The video manual creation device (10B) in supplement 1 includes: a worker detection unit (118) configured to detect the worker from the video; a worker video clipping unit (119) configured to clip frames including the worker detected by the worker detection unit (118) ; and an alarm handling video clipping unit (120) configured to clip frames from a time of occurrence to a time of release of an alarm in the machine (30), in which the video creation unit (114b) creates a video displaying the button operated by the worker on the registered image of the operation panel (31) when the frame detected by the frame detection unit (113) is displayed in a range of the frames clipped in the worker video clipping unit (119) and the frames clipped in the alarm handling video clipping unit (120).

### (Supplement 4)

A video manual creation method for causing a computer to function as a video manual creation device (10), the video manual creation method including: a machine operation panel registration step of registering an image of an operation panel (31) of a machine (30) ; a signal registration step of registering each button on the operation panel (31) in the registered image and a signal for controlling the operation panel (31) by an operation of each button on the operation panel (31) in association with each other; a signal data change time extraction step of extracting a time of a change in the registered signal; a frame detection step of detecting, based on the extracted time, from a video including an operation performed on the operation panel (31) by a worker, a frame at which a button corresponding to the changed signal was operated by the worker; and a video creation step of creating a video displaying the button that was operated by the worker on the registered image of the operation panel (31) when the detected frame is displayed.

### EXPLANATION OF REFERENCE NUMERALS

1 video manual creation system
10, 10A, 10B video manual creation device
11 control unit
110 operation panel registration unit
111 signal registration unit
112 signal data change time extraction unit
113, 113a frame detection unit
114, 114b video creation unit
115 operation panel detection unit
116 joint position estimation unit
117 operation panel use time detection unit
118 worker detection unit
119 worker video clipping unit
120 alarm handling video clipping unit
12 input unit
13 display unit
14 storage unit
141 video data storage unit
142 signal data storage unit
20 camera
30 machine
31 operation panel

1. A video manual creation device, comprising:
a machine operation panel registration unit configured to register an image of an operation panel of a machine;
a signal registration unit configured to register each button on the operation panel in the image registered by the machine operation panel registration unit and a signal for controlling the operation panel by an operation of each button on the operation panel in association with each other;
a signal data change time extraction unit configured to extract a time of a change in the signal registered in the signal registration unit;
a frame detection unit configured to detect, based on the time extracted by the signal data change time extraction unit, from a video including an operation performed on the operation panel by a worker, a frame at which a button corresponding to the changed signal was operated by the worker; and
a video creation unit configured to create a video displaying the button that was operated by the worker on the image of the operation panel registered by the machine operation panel registration unit when the frame detected by the frame detection unit is displayed.

2. The video manual creation device according to claim 1, further comprising:
an operation panel detection unit configured to detect an image area of the operation panel from the video;
a joint position estimation unit configured to estimate a joint position of the worker from the video; and
an operation panel use time detection unit configured to, based on the image area of the operation panel detected by the operation panel detection unit and the joint position of the worker estimated by the joint position estimation unit, detect a time of the worker using the operation panel in the video that is before the time extracted in the signal data change time extraction unit, wherein
the frame detection unit detects, based on the time detected by the operation panel use time detection unit, a frame capturing the operation performed by the worker.

3. The video manual creation device according to claim 1, further comprising:
a worker detection unit configured to detect the worker from the video;
a worker video clipping unit configured to clip frames including the worker detected by the worker detection unit; and
an alarm handling video clipping unit configured to clip frames from a time of occurrence to a time of release of an alarm in the machine, wherein
the video creation unit creates a video displaying the button operated by the worker on the registered image of the operation panel when the frame detected by the frame detection unit is displayed in a range of the frames clipped in the worker video clipping unit and the frames clipped in the alarm handling video clipping unit.

4. A video manual creation method for causing a computer to function as a video manual creation device, the video manual creation method including:
a machine operation panel registration step of registering an image of an operation panel of a machine;
a signal registration step of registering each button on the operation panel in the registered image and a signal for controlling the operation panel by an operation of each button on the operation panel in association with each other;
a signal data change time extraction step of extracting a time of a change in the registered signal;
a frame detection step of detecting, based on the extracted time, from a video including an operation performed on the operation panel by a worker, a frame at which a button corresponding to the changed signal was operated by the worker; and
a video creation step of creating a video showing the button that was operated by the worker on the registered image of the operation panel when the detected frame is displayed.
